(19) United States
(12) Patent Application Publication
(10) Pub. No.: US 2017/0323149 A1
(43) Pub. Date: Nov. 9, 2017

(54) ROTATION INVARIANT OBJECT DETECTION

(71) Applicant: International Business Machines Corporation, Armon, NY (US)

(72) Inventors: Sivan Harary, Manof (IL); Mattias Marder, Haifa (IL)

(21) Appl. No.: 15/146,905

(22) Filed: May 5, 2016

(51) Int. Cl. G06K 9/00; G06K 9/62; G06T 3/00

(52) U.S. Cl. CPC G06K 9/00208; G06T 3/00; G06K 9/6215; G06T 2207/20048; G06T 2207/10004

(57) ABSTRACT

A method, including receiving a two-dimensional (2D) image of a three-dimensional (3D) object recorded at a first angle of rotation of the object, and identifying, in the 2D image, a set of image descriptors, each of the image descriptors including an image keypoint and one or more image features. The set of image descriptors are compared against sets of template descriptors for respective previously captured 2D images, each of the template descriptors comprising a template keypoint and one or more template features. Using a threshold, a given set of template descriptors matching the set of image descriptors are identified, the given set of template descriptors corresponding to a given previously captured 2D image of the 3D object recorded at a second angle of rotation of the object. Any of the image descriptors not in the given set of the template descriptors are added to the given set of template descriptors.

### FIELD OF THE INVENTION

The present invention relates generally to image analysis, and specifically to defining an extended image canvas that can use two-dimensional images to identify rotated three-dimensional objects.

### BACKGROUND

In digital image processing, computer-based algorithms are used to perform image processing on digital images. Examples of approaches that can be used for digital image processing include template-based approaches and feature-based approaches.

When analyzing an image using a feature-based approach, local decisions can be made at every image point in order to determine whether there is an image feature of a given type at that point or not. The resulting features can then be defined as subsets of the image's domain, often in the form of isolated points, continuous curves or connected regions. Examples of features include edges, corners, interest points, blobs, regions of interest (also referred to as interest points) and ridges.

Template-based approaches are typically used when analyzing a digital image that does not have any strong features. When using a template-based approach to perform a comparison of a digital image against a group of template images (e.g., stored in a database), the objective can be to identify small parts of the digital image that match a given template image.

The description above is presented as a general overview of related art in this field and should not be construed as an admission that any of the information it contains constitutes prior art against the present patent application.

### SUMMARY

There is provided, in accordance with an embodiment of the present invention a method, including receiving a two-dimensional image of a three-dimensional object recorded at a first angle of rotation of the object, identifying, in the two-dimensional image, a set of image descriptors, each of the image descriptors including an image keypoint and one or more image features, comparing the set of image descriptors against a plurality of sets of template descriptors for respective previously captured two-dimensional images, each of the template descriptors including a template keypoint and one or more template features, identifying, based on a defined threshold, a given set of template descriptors matching the set of image descriptors, the given set of template descriptors corresponding to a given previously captured two-dimensional image of the three-dimensional object recorded at a second angle of rotation of the object, and adding, to the given set of template descriptors, any of the image descriptors not in the given set of the of template descriptors.

There is also provided, in accordance with an embodiment of the present invention an apparatus, including a storage device configured to store multiple sets of template descriptors for respective previously captured two-dimensional images, each of the template descriptors including a template keypoint and one or more template features, and a processor configured to receive a two-dimensional image of a three-dimensional object recorded at a first angle of rotation of the object, to identify, in the two-dimensional image, a set of image descriptors, each of the image descriptors including an image keypoint and one or more image features, to compare the set of image descriptors against the multiple sets of template descriptors, to identify, based on a defined threshold, a given set of template descriptors matching the set of image descriptors, the given set of template descriptors corresponding to a given previously captured two-dimensional image of the three-dimensional object recorded at a second angle of rotation of the object, and to add, to the given set of template descriptors, any of the image descriptors not in the given set of the of template descriptors.

There is further provided, in accordance with an embodiment of the present invention a computer program product, the computer program product including a non-transitory computer readable storage medium having computer readable program code embodied therewith, the computer readable program code including computer readable program code configured to receive a two-dimensional image of a three-dimensional object recorded at a first angle of rotation of the object, computer readable program code configured to identify, in the two-dimensional image, a set of image descriptors, each of the image descriptors including an image keypoint and one or more image features, computer readable program code configured to compare the set of image descriptors against a plurality of sets of template descriptors for respective previously captured two-dimensional images, each of the template descriptors including a template keypoint and one or more template features, computer readable program code configured to identify, based on a defined threshold, a given set of template descriptors matching the set of image descriptors, the given set of template descriptors corresponding to a given previously captured two-dimensional image of the three-dimensional object recorded at a second angle of rotation of the object, and computer readable program code configured to add, to the given set of template descriptors, any of the image descriptors not in the given set of the of template descriptors.

### BRIEF DESCRIPTION OF THE DRAWINGS

The disclosure is herein described, by way of example only, with reference to the accompanying drawings, wherein:

FIG. 1 is a block diagram that schematically illustrates a computer system configured to using a virtual canvas to perform rotation invariant object detection of rotated three-dimensional objects, in accordance with an embodiment of the present invention;

FIG. 2 is a schematic pictorial illustration of the virtual image canvas comprising a set of descriptors for a three-dimensional object recorded at an initial angle of rotation of the object, in accordance with an embodiment of the preset invention;

FIG. 3 is a schematic pictorial illustration of extending the virtual image canvas to accommodate additional descriptors that were identified for the three-dimensional object recorded at additional angles of rotation of the object, in accordance with an embodiment of the preset invention;

FIG. 4 is a flow diagram that schematically illustrates a method of using the extended image canvas to perform rotation invariant object detection, in accordance with an embodiment of the preset invention;

FIG. 5 is a schematic pictorial illustration of a captured two-dimensional image matching the virtual image canvas, in accordance with a first embodiment of the present invention;

FIG. 6 is a schematic pictorial illustration of a captured two-dimensional image matching the virtual image canvas, in accordance with a second embodiment of the present invention; and

FIG. 7 is a schematic pictorial illustration of template images of the three-dimensional object that can be combined based on a two-dimensional image recorded at a further angle of rotation of the object, in accordance with an embodiment of the present invention.

### DETAILED DESCRIPTION OF EMBODIMENTS

Embodiments of the present invention provide methods and systems for using local image registrations and an extended image canvas to generate an unsupervised and incremental creation of a simplified image model for a three-dimensional object. As described hereinbelow, upon receiving a two-dimensional image of a three-dimensional object recorded at a first angle of rotation of the object, a set of image descriptors are identified in the two-dimensional image, each of the image descriptors comprising an image keypoint and one or more image features. The set of image descriptors are compared against a plurality of sets of template descriptors for respective previously acquired two-dimensional images, each of the template descriptors comprising a template keypoint and one or more template features. Based on a defined threshold, a given set of template descriptors matching the set of image descriptors are identified, the given set of template descriptors corresponding to a given previously acquired two-dimensional image of the three-dimensional object recorded at a second angle of rotation of the object.

In some embodiments, a given set of template descriptors matching the set of image descriptors can be identified by matching, based on the defined threshold (e.g., a confidence level), a subset of the given set of template descriptors to a subset of the set of image descriptors. In additional embodiments, any of the image descriptors that are not in the given set of template descriptors can be added to the given set of template descriptors. In embodiments of the present invention, each set of the image descriptors has its own coordinate system, and prior to adding a given image descriptor to the given set of template descriptors, the coordinates indicated by the given image descriptor's keypoint are transformed to the coordinate system of the given set of template descriptors.

Systems implementing embodiments of the present invention enable adding previously unseen two-dimensional views of a three-dimensional object to an existing virtual image canvas, effectively creating an adaptive system that can quickly learn to detect three-dimensional objects from two-dimensional images of three-dimensional objects recorded at multiple angles of rotation of the object. This enables the system to analyze an acquired two-dimensional image to quickly detect a match between the acquired two-dimensional image and a previously acquired two-dimensional image of the three-dimensional object that was recorded at a different angle of rotation of the object. Additionally, by adding, to the three-dimensional object's virtual image canvas, new attributes identified in the acquired image, the system can improve future detection rates for the three dimensional object.

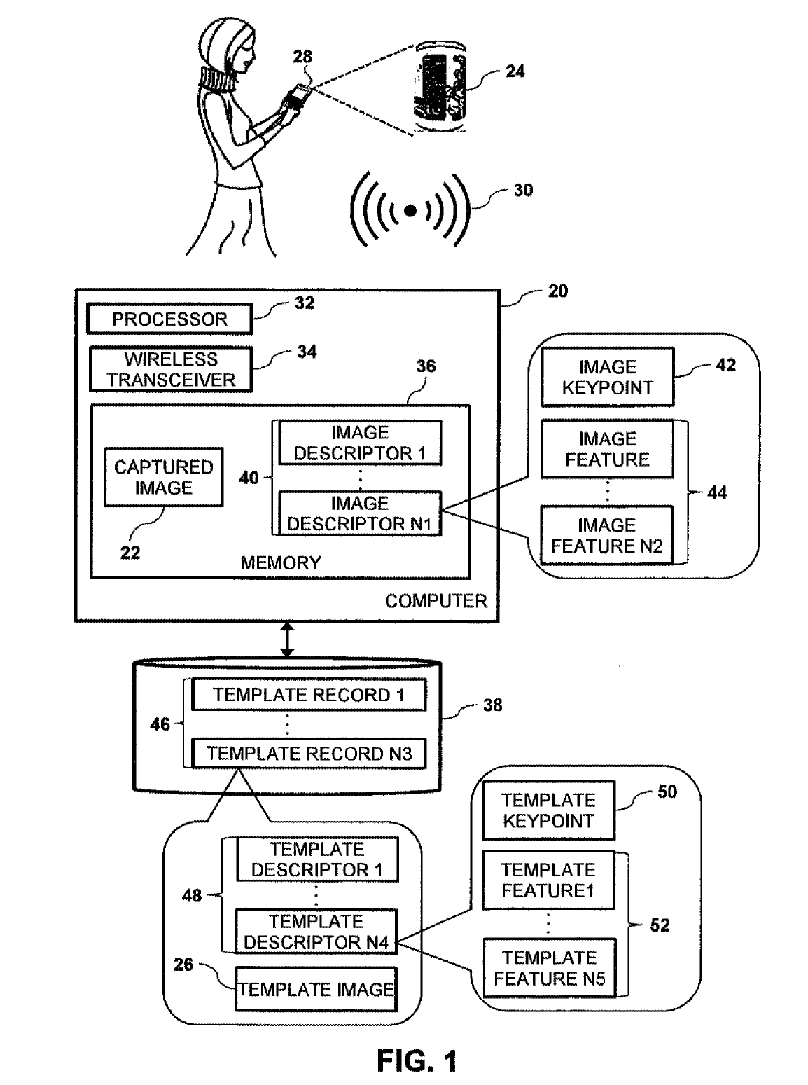

FIG. 1 is a block diagram that schematically illustrates a computer 20 configured to receive a captured two-dimensional (2D) image 22 of a three-dimensional (3D) object 24, and match the captured image to a previously acquired template image 26 of the 3D object, in accordance with an embodiment of the invention. In the example shown in FIG. 1, a portable computing device 28 (e.g., a smartphone) captures a 2D image 22 of 3D object 24, and conveys the captured 2D image to computer 20 via a wireless connection 30.

Computer 20 comprises a processor 32, a wireless transceiver 34, a memory 36 and a storage device 38 such as a hard disk drive or a solid-state disk drive. Wireless transceiver 34 is configured to receive captured image 22 from device 28, and stored the captured 2D image to memory 36. As described hereinbelow, processor 32 is configured to identify, in captured image 22, multiple image descriptors 40 and to store the identified image descriptors to memory 36.

Each image descriptor 40 comprises an image keypoint 42 and one or more image features 44. For a given image descriptor 40, each image keypoint 42 indicates a location (e.g., coordinates) in image 22, and each image feature 44 comprising a description of an area in the captured image indicated by the image keypoint (e.g., an edge, a corner, a blob, and a ridge).

Storage device 38 stores template records 46, each of the template records comprising template descriptors 48 for a given previously captured (and analyzed) template image 26. Each template descriptor 48 comprises a template keypoint 50 indicating a location in the template image and one or more template features comprising a description of an area in the template image indicated by the template keypoint.

As described hereinbelow, processor 32 may use multiple captured images 22 of object 24 to generate the template descriptors for a given template record 46. For example, processor 32 can receive a first captured image 22 of object 24 that portable computing device 28 recorded at a first angle of rotation of the object, identify a first set of image descriptors 40 in the first captured image, and store the first set of image descriptors to the template descriptors in a given template record 46. Upon receiving a second captured image 22 of object 24 that portable computing device 28 recorded at a second angle of rotation of the object, processor 32 can identify a second set of image descriptors 40 in the second captured image that were not in the first set of image descriptors, and add the second set of image descriptors to the template descriptors in the given template record.

In embodiments of the present invention, template descriptors function as a “virtual image canvas”, since they can store template features 52 that that were identified at different angles of rotation of the object. For example, the template descriptors may comprise template features from both the front of object 24 and the back of object 24.

Processor 32 comprises a general-purpose central processing unit (CPU) or special-purpose embedded processors, which are programmed in software or firmware to carry out the functions described herein. The software may be downloaded to computer 20 in electronic form, over a network, for example, or it may be provided on non-transitory tangible media, such as optical, magnetic or electronic memory media. Alternatively, some or all of the functions of processor 32 may be carried out by dedicated or programmable digital hardware components, or using a combination of hardware and software elements.

The present invention may be a system, a method, and/or a computer program product. The computer program product may include a computer readable storage medium (or media) having computer readable program instructions thereon for causing a processor to carry out aspects of the present invention.

The computer readable storage medium can be a tangible device that can retain and store instructions for use by an instruction execution device. The computer readable storage medium may be, for example, but is not limited to, an electronic storage device, a magnetic storage device, an optical storage device, an electromagnetic storage device, a semiconductor storage device, or any suitable combination of the foregoing. A non-exhaustive list of more specific examples of the computer readable storage medium includes the following: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device such as punch-cards or raised structures in a groove having instructions recorded thereon, and any suitable combination of the foregoing. A computer readable storage medium, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

Computer readable program instructions described herein can be downloaded to respective computing/processing devices from a computer readable storage medium or to an external computer or external storage device via a network, for example, the Internet, a local area network, a wide area network and/or a wireless network. The network may comprise copper transmission cables, optical transmission fibers, wireless transmission, routers, firewalls, switches, gateway computers and/or edge servers. A network adapter card or network interface in each computing/processing device receives computer readable program instructions from the network and forwards the computer readable program instructions for storage in a computer readable storage medium within the respective computing/processing device.

Computer readable program instructions for carrying out operations of the present invention may be assembler instructions, instruction-set-architecture (ISA) instructions, machine instructions, machine dependent instructions, microcode, firmware instructions, state-setting data, or either source code or object code written in any combination of one or more programming languages, including an object oriented programming language such as Smalltalk, C++ or the like, and conventional procedural programming languages, such as the “C” programming language or similar programming languages. The computer readable program instructions may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider). In some embodiments, electronic circuitry including, for example, programmable logic circuitry, field-programmable gate arrays (FPGA), or programmable logic arrays (PLA) may execute the computer readable program instructions by utilizing state information of the computer readable program instructions to personalize the electronic circuitry, in order to perform aspects of the present invention.

Aspects of the present invention are described herein with reference to flowchart illustrations and/or block diagrams of methods, apparatus (systems), and computer program products according to embodiments of the invention. It will be understood that each block of the flowchart illustrations and/or block diagrams, and combinations of blocks in the flowchart illustrations and/or block diagrams, can be implemented by computer readable program instructions.

These computer readable program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks.

These computer readable program instructions may also be stored in a computer readable storage medium that can direct a computer, a programmable data processing apparatus, and/or other devices to function in a particular manner, such that the computer readable storage medium having instructions stored therein comprises an article of manufacture including instructions which implement aspects of the function/act specified in the flowchart and/or block diagram block or blocks.

The computer readable program instructions may also be loaded onto a computer, other programmable data processing apparatus, or other device to cause a series of operational steps to be performed on the computer, other programmable apparatus or other device to produce a computer implemented process, such that the instructions which execute on the computer, other programmable apparatus, or other device implement the functions/acts specified in the flowchart and/or block diagram block or blocks.

### Rotated Three-Dimensional Object Detection

As described supra, the set of template descriptors for a given template record 46 can be configured as a “virtual image canvas”. In embodiments described herein, processor 32 can define a virtual image canvas by storing, to the template descriptors in a given template record 46, a set of image descriptors 40 from a first captured image 22 of a given object 24 that portable computing device 28 recorded at a first angle of rotation of the object. Upon receiving a second captured image of the given object recorded at a second angle of rotation of the object, processor 32 can “extend” the virtual image canvas with any image descriptors 40 that do not match any of the template descriptors in the given template record.

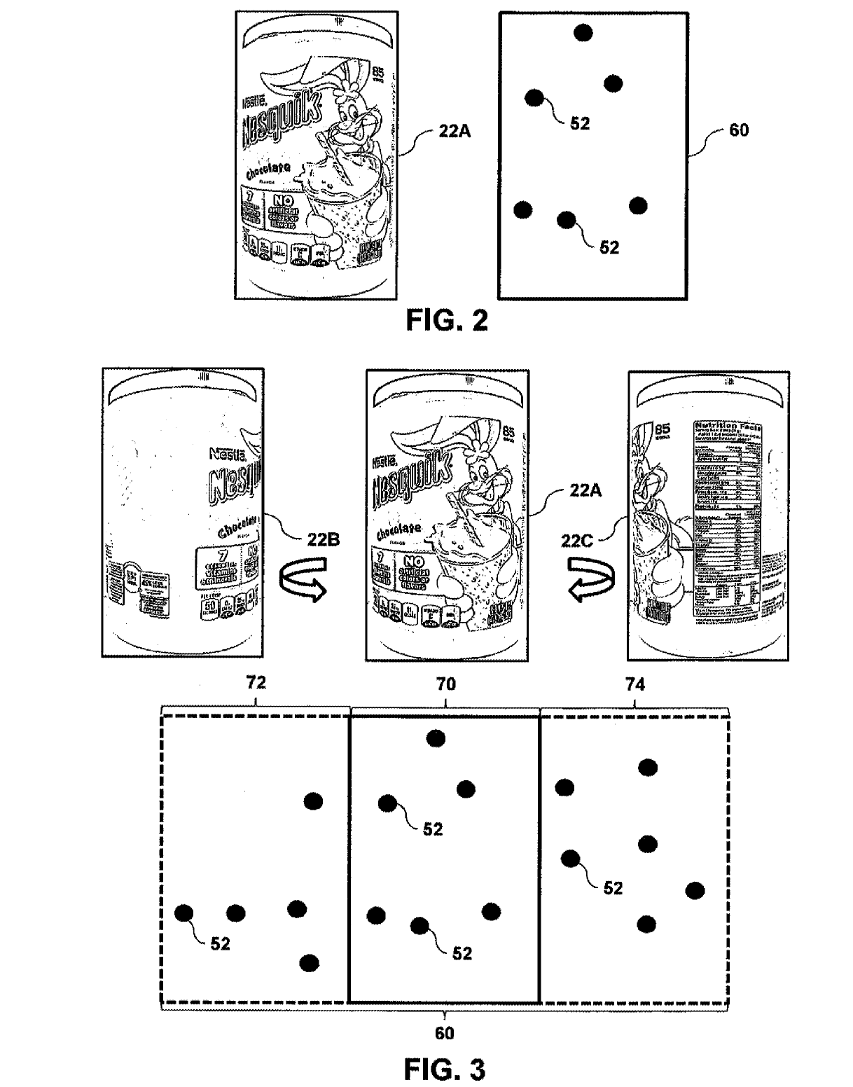

FIG. 2 is a schematic pictorial illustration of a virtual image canvas 60 comprising a set of template descriptors 48 for a first captured image 22 of a three-dimensional object (e.g., object 24) that portable computing device 28 recorded at a first angle of rotation of the object, in accordance with an embodiment of the preset invention. The examples of virtual image canvas 60 that are presented herein show template features 52 for object 24 presented at virtual locations on the virtual image canvas that correspond to their respective template keypoints 50.

In embodiments described herein, captured images 22 are differentiated by appending a letter to the identifying numeral, so that the captured images comprise captured images 22A-22E. In FIG. 2, the first captured image may also be referred to as captured image 22A.

FIG. 3 is a schematic pictorial illustration of extending virtual image canvas 60 to accommodate additional template descriptors 48 identified upon receiving additional captured images 22B and 22C for three-dimensional object 24 that portable computing device 28 recorded at additional angles of rotation of the object, in accordance with an embodiment of the preset invention. In the example shown in FIG. 3, extended virtual image canvas 60 comprises sub-canvases 70, 72 and 74, wherein sub-canvas 70 comprises template descriptors 48 that processor 32 identified in captured image 22A that portable computing device 28 recorded at a first angle of rotation of the object, sub-canvas 72 comprises additional template descriptors 48 that processor 32 identified in captured image 22B that the portable computing device recorded at a second angle of rotation of the object, and sub-canvas 74 comprises additional template descriptors 48 that processor 32 identified in captured image 22C that the portable computing device recorded at a third angle of rotation of the object. The additional template descriptors 48 comprise new template descriptors 48 identified in images 22B and 22C that processor 32 did not identify in images 22A, and were therefore not stored in sub-canvas 70.

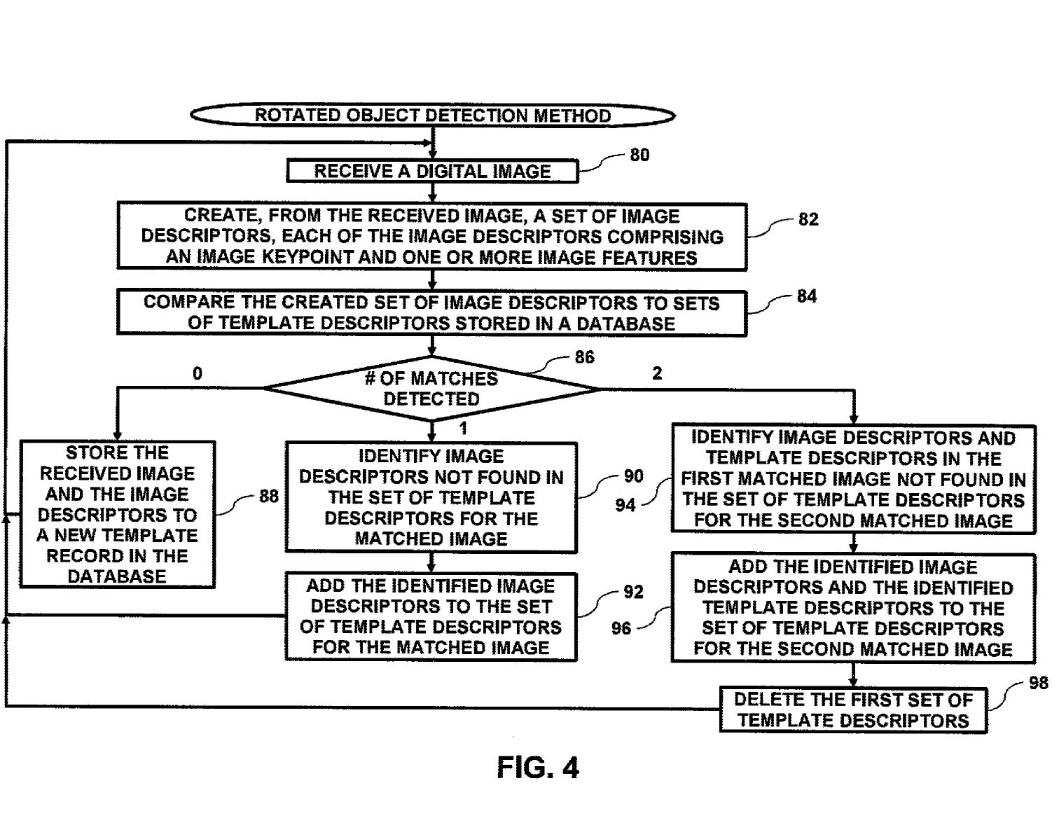

FIG. 4 is a flow diagram that schematically illustrates a method of matching captured image 22 of object 24 that portable computing device 28 recorded at a first angle of rotation of the object to a given template image 26 of the 3D object that the portable computing device previously recorded at a second angle of rotation of the object, in accordance with an embodiment of the present invention. In a receive step 80, processor 32 receives captured image 22 of object 24, and in a generation step 82, the processor analyzes the captured image and generates a set of image descriptors 40.

In a comparison step 84, processor 32 compares captured digital image 22 to template images 26 to see if any of the template images comprise object 24. In embodiments of the present invention, processor 32 compares captured digital image 22 to a given template image 26 by comparing image descriptors 40 (i.e., tuples of image keypoints 42 and image features 44) to the template descriptors (i.e., tuples of template keypoints 50 and template features 52) for the given image. Additionally, since processor compares image descriptors 40 that processor 32 computed for captured image 22 of 3D object 24 recorded by portable computing device 28 at a first angle of rotation of the 3D object to a given set of template descriptors 48 that the processor computed for a given template image 26 of the 3D object recorded by portable computing device 28 at a second angle of rotation of the object, detecting a match between the image descriptors and the given set of template descriptors typically comprises matching a subset of the image descriptors to a subset of the given set of template descriptors.

To compare image descriptors 40 to a given set of template descriptors 48, processor 32 can first compare the image features (regardless of the keypoints) using a defined threshold on the distances (e.g., in a feature space) between the image features and the template features in the given set of template descriptors. In one embodiment, processor 32 can use a kd-tree space partitioning data structure for organizing, in a k-dimensional space, the image features and the template features in the given set of template descriptors.

In an alternative embodiment, processor 32 can use a brute force method in order to review over all possible pairs of the image features and the template features in the given set of template descriptors. The brute force method uses pairs of potentially matching image and template descriptors that processor 32 can check for potential matches between their respective image keypoints 42 and template keypoints 50. To check for the matches, processor 32 can identify a geometrical transformation that fits the largest number of matching pairs. In operation, when applying the transformation on the first descriptor in the pair (i.e., a given image descriptor 40), the processor provides the second descriptor in the pair (i.e., a given template descriptor 48).

Since there is typically no single geometric transformation that fits all the pairs, processor 32 can identify a geometric transformation that “fits” the highest number of the pairs. Upon identifying the geometric transformation, processor 32 can drop any descriptor pairs that do not match the identified transformation. To identify any of the descriptor pairs that do not match the identified transformation processor 32 can use methods such as (a) voting, which can identify several occurrences of identical 3D objects in the captured image, and (b) random sample consensus (RANSAC), which assumes only one occurrence of a given 3D image on the captured image.

In some embodiments, processor 32 can use a voting method which matches image descriptors 40 to each set of template descriptors 48, thereby computing a confidence level for each set of template descriptors 48, wherein the confidence level can be dependent on the number captured images 22 used to create virtual image canvas 60. Therefore, processor 32 can use the voting method find the best region (i.e., of the size of object 24 in virtual image canvas 60) that includes the matching template keypoints 50, and calculate a template-query distance using only the template keypoints in this region. Using the voting method this typically comprises processor 32 counting both the number of template keypoints 50 in this region and the number of template keypoints 50 that match image keypoints 42 (or summarizing the weights of the matching template keypoints if available).

In a comparison evaluation step 86, if there are no matches between image descriptors 40 and any given set of template descriptors 48, then in a storing step 88, processor 32 adds a new template record 46, stores image descriptors 40 to the template descriptors in the added record, stores captured image 22 to the template image for the given record, and the method continues with step 80. In operation, processor 32 does not detect a match if either (a) none of the template images in the template records comprise object 24, or (b) there is a given template image 26 of object 24, but the angle of rotation between the given template image and captured image 22 is too high.

When generating a set of image descriptors for captured image 22 in step 82, processor 32 defines an (x,y) coordinate system for the image keypoints in the set of image descriptors. Therefore, the image descriptors stored to the added template record reference the defined coordinate system.

Returning to step 86, if there is a match between image descriptors 40 and a given set of template descriptors 48, then processor 32 identifies any image descriptors 40 not in the given set of template descriptors in a first identification step 90, adds the identified image descriptors to the given set of template descriptors in a first addition step 92, and the method continues with step 80. Prior to adding the identified image descriptors to the given set of template descriptors, processor 32 can perform a geometric transformation to transform the image keypoints in the identified image descriptors to the coordinate system of the given set of template descriptors.

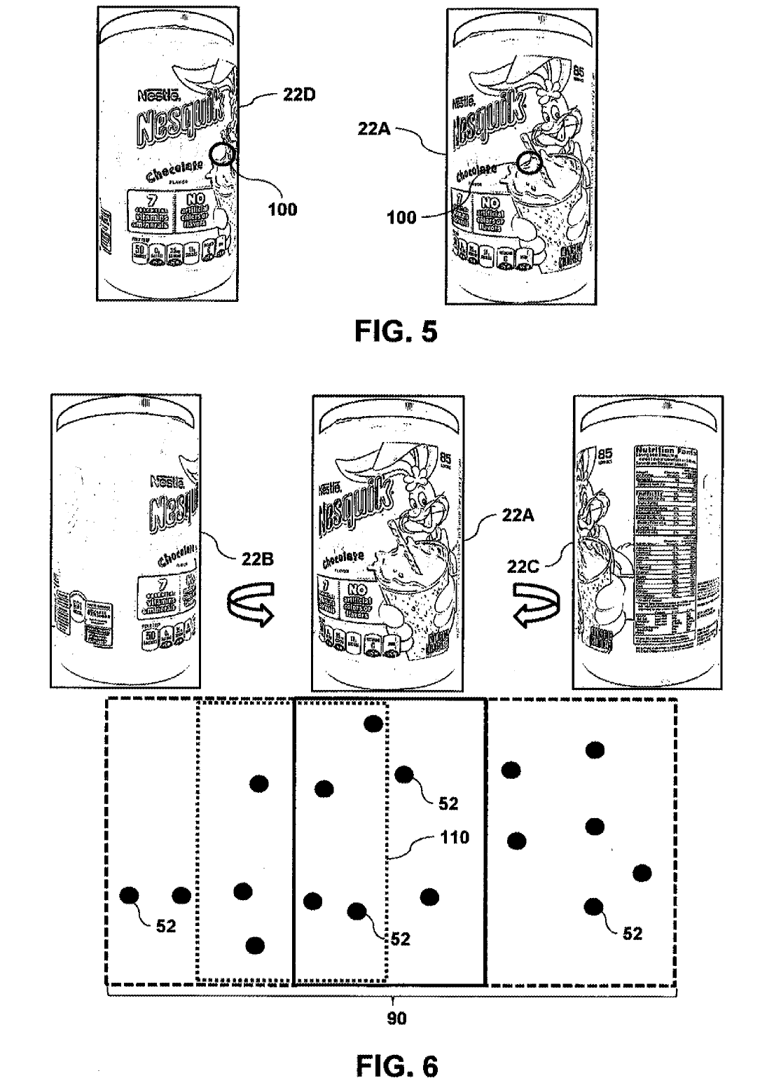

FIG. 5 is a schematic pictorial illustration of matching captured image 22 to virtual image canvas 60, in accordance with a first embodiment of the present invention. In the example shown in FIG. 5, processor 32 compares a captured image 22D recorded by portable computing device 28 at a first angle of rotation of the object to virtual image canvas 60 that the processor generated based solely on previously captured image 22A recorded by portable computing device at a second angle of rotation of the object. While detecting the match, processor 32 can identify an image hotspot 100 that comprises a geometric center of image 22A, which in this case is stored to a given template image 26. In FIG. 5, image hotspot 100 is presented both in image 22A and in image 22D where the location of the hotspot is offset due to the different angle of rotation of 3D object 24 in image 22D (i.e., compared to the angle of rotation of the 3D object in image 22A).

FIG. 6 is a schematic pictorial illustration of matching captured image 22 to virtual image canvas 60, in accordance with a second embodiment of the present invention. In the example shown in FIG. 6, processor 32 compares captured image 22D recorded by portable computing device 28 at a first angle of rotation of the object to a given virtual image canvas 60 that the processor generated based on captured images 22A-22C recorded by portable computing device at respective additional angles of rotation of the object. To detect the match, processor 32 identifies a region of interest 110 on virtual image canvas 60 comprising template descriptors 48 that match image descriptors 40, and therefore matches captured image 22D to the template record storing the given virtual image canvas.

Returning to step 86 in the flow diagram shown in FIG. 4, if there are matches, between image descriptors 40 and two given sets of template descriptors 48 (i.e., a first given set of template descriptors and a second given set of template descriptors), then in a second identification step 94, processor identifies any image descriptors 40, and any template descriptors 48 in the first given set of template descriptors, that are not in the second given set of template descriptors. In a second addition step 96, the processor adds the identified image descriptors and the identified template descriptors to the second given set of template descriptors. Prior to adding the identified image descriptors and the identified template descriptors to the second given set of template descriptors, processor 32 can perform a geometric transformation to transform the image keypoints in the identified image descriptors and the template keypoints in the first given set of template descriptors to the coordinate system of the second given set of template descriptors. Finally, in a deletion step 98, processor 32 deletes the template record storing the first given set of template descriptors, and the method continues with step 80.

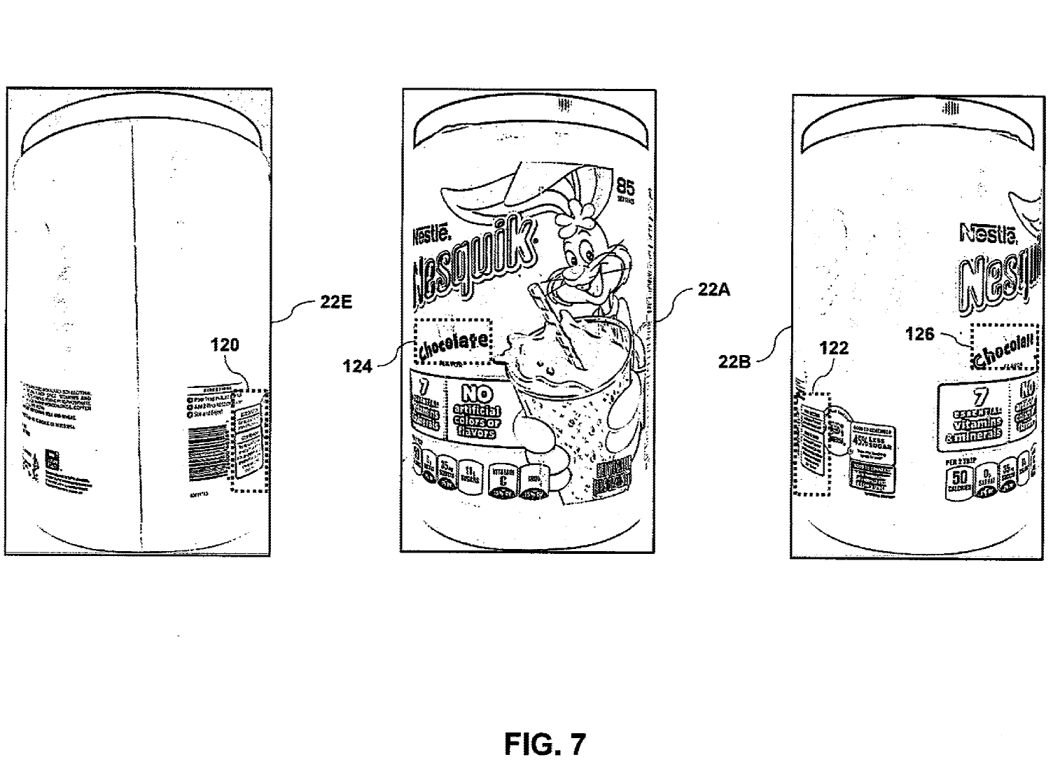

FIG. 7 is a schematic pictorial illustration of identifying template records 46 that can be merged since they comprise respective template descriptors 48 that processor 32 computed upon receiving captured images 22 of 3D object 24 recorded by portable computing device 28 at different angles of rotation of 3D object 24, in accordance with an embodiment of the present invention. In the example shown in FIG. 7, a first given template record 46 comprises template descriptors 48 that processor 32 computed upon receiving captured template image 22A recorded at a first angle of rotation of the object, and a second given template record 22E comprises template descriptors 48 that processor 32 computed upon receiving captured template image 22E recorded at a second angle of rotation of the object. Since there is (approximately) a 180 degree angle of rotation between captured images 22A and 22D, the first and the second given template records do not share any common template descriptors 48.

Upon processor 32 receiving captured image 22B recorded by portable computing device 28 at a third angle of rotation of the object the processor can detect that the image descriptors 40 in a region of interest 120 matches the template descriptors in a region of interest 122, and that the image descriptors 40 in a region of interest 124 matches the template descriptors in a region of interest 126. Therefore, using embodiments of the present invention, processor 32 can determine that the first and the second given template records are both for a given 3D object such as 3D object 24, and merge the template descriptors of both of the given template records, as described supra in steps 94-98.

The flowchart(s) and block diagrams in the Figures illustrate the architecture, functionality, and operation of possible implementations of systems, methods and computer program products according to various embodiments of the present invention. In this regard, each block in the flowchart or block diagrams may represent a module, segment, or portion of code, which comprises one or more executable instructions for implementing the specified logical function(s). It should also be noted that, in some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts, or combinations of special purpose hardware and computer instructions.

It will be appreciated that the embodiments described above are cited by way of example, and that the present invention is not limited to what has been particularly shown and described hereinabove. Rather, the scope of the present invention includes both combinations and subcombinations of the various features described hereinabove, as well as variations and modifications thereof which would occur to persons skilled in the art upon reading the foregoing description and which are not disclosed in the prior art.

1. A method, comprising:
receiving a two-dimensional image of a three-dimensional object recorded at a first angle of rotation of the object;
identifying, in the two-dimensional image, a set of image descriptors, each of the image descriptors comprising an image keypoint and one or more image features;
comparing the set of image descriptors against a plurality of sets of template descriptors for respective previously captured two-dimensional images, each of the template descriptors comprising a template keypoint and one or more template features;
identifying, based on a defined threshold, a given set of template descriptors matching the set of image descriptors, the given set of template descriptors corresponding to a given previously captured two-dimensional image of the three-dimensional object recorded at a second angle of rotation of the object; and
adding, to the given set of template descriptors, any of the image descriptors not in the given set of the of template descriptors.

2. The method according to claim 1, and further comprising adding the set of image descriptors to the sets of template descriptors upon failing to identify a given set of template descriptors matching the set of image descriptors.

3. The method according to claim 1, wherein the template keypoints in set of template descriptors comprise a first coordinate system, wherein image keypoints in the set of image descriptors comprise a second coordinate system, and wherein adding the any of the image descriptors not in the given set of the of template descriptors to the given set of template descriptors comprises performing a geometric transformation to transform the image keypoints in any of the image keypoints to the first coordinate system.

4. The method according to claim 1, wherein identifying a given set of template descriptors matching the set of image descriptors comprises matching, based on the defined threshold, a subset of the given set of template descriptors to a subset of the set of image descriptors.

5. The method according to claim 4, wherein the subset of the set of image descriptors comprises a first subset of image descriptors, wherein the given set of template descriptors comprises a first given set of template descriptors, wherein the given previously captured image comprises a first given previously captured image, and further comprising: matching, based on the defined threshold, a subset of a second given set of template descriptors to a second subset of the set of image descriptors, the second given set of template descriptors corresponding to a second given previously captured two-dimensional image of the three-dimensional object recorded at a third angle of rotation of the object, adding, to the first given set of template descriptors, any of the template descriptors in the second given set of template descriptors not in the first given set of template descriptors and any of the image descriptors not in the first given set of template descriptors, and deleting the second given set of template descriptors.

6. The method according to claim 1, wherein the defined threshold comprises a confidence level.

7. An apparatus, comprising:
a storage device configured to store multiple sets of template descriptors for respective previously captured two-dimensional images, each of the template descriptors comprising a template keypoint and one or more template features; and
a processor configured:
to receive a two-dimensional image of a three-dimensional object recorded at a first angle of rotation of the object,
to identify, in the two-dimensional image, a set of image descriptors, each of the image descriptors comprising an image keypoint and one or more image features,
to compare the set of image descriptors against the multiple sets of template descriptors,
to identify, based on a defined threshold, a given set of template descriptors matching the set of image descriptors, the given set of template descriptors corresponding to a given previously captured two-dimensional image of the three-dimensional object recorded at a second angle of rotation of the object, and
to add, to the given set of template descriptors, any of the image descriptors not in the given set of the of template descriptors.

8. The apparatus according to claim 7, wherein the processor is further configured to add the set of image descriptors to the sets of template descriptors upon failing to identify a given set of template descriptors matching the set of image descriptors.

9. The apparatus according to claim 7, wherein the template keypoints in set of template descriptors comprise a first coordinate system, wherein image keypoints in the set of image descriptors comprise a second coordinate system, and wherein the processor is further configured to add the any of the image descriptors not in the given set of the of template descriptors to the given set of template descriptors by performing a geometric transformation to transform the image keypoints in the any of the image keypoints to the first coordinate system.

10. The apparatus according to claim 7, wherein the processor is configured to identify a given set of template descriptors matching the set of image descriptors by matching, based on the defined threshold, a subset of the given set of template descriptors to a subset of the set of image descriptors.

11. The apparatus according to claim 10, wherein the subset of the set of image descriptors comprises a first subset of image descriptors, wherein the given set of template descriptors comprises a first given set of template descriptors, wherein the given previously captured image comprises a first given previously captured image, and wherein the processor is further configured: to match, based on the defined threshold, a subset of a second given set of template descriptors to a second subset of the set of image descriptors, the second given set of template descriptors corresponding to a second given previously captured two-dimensional image of the three-dimensional object recorded at a third angle of rotation of the object, to add, to the first given set of template descriptors, any of the template descriptors in the second given set of template descriptors not in the first given set of template descriptors and any of the image descriptors not in the first given set of template descriptors, and to delete the second given set of template descriptors.

12. The apparatus according to claim 7, wherein the defined threshold comprises a confidence level.

13. A computer program product, the computer program product comprising:
a non-transitory computer readable storage medium having computer readable program code embodied therewith, the computer readable program code comprising:
computer readable program code configured to receive a two-dimensional image of a three-dimensional object recorded at a first angle of rotation of the object;
computer readable program code configured to identify, in the two-dimensional image, a set of image descriptors, each of the image descriptors comprising an image keypoint and one or more image features;
computer readable program code configured to compare the set of image descriptors against a plurality of sets of template descriptors for respective previously captured two-dimensional images, each of the template descriptors comprising a template keypoint and one or more template features;
computer readable program code configured to identify, based on a defined threshold, a given set of template descriptors matching the set of image descriptors, the given set of template descriptors corresponding to a given previously captured two-dimensional image of the three-dimensional object recorded at a second angle of rotation of the object; and
computer readable program code configured to add, to the given set of template descriptors, any of the image descriptors not in the given set of the of template descriptors.

14. The computer program product according to claim 13, and further comprising computer readable program code configured to add the set of image descriptors to the sets of template descriptors upon failing to identify a given set of template descriptors matching the set of image descriptors.

15. The computer program product according to claim 13, wherein the template keypoints in set of template descriptors comprise a first coordinate system, wherein image keypoints in the set of image descriptors comprise a second coordinate system, and wherein the computer readable program code is configured to add the any of the image descriptors not in the given set of the of template descriptors to the given set of template descriptors by performing a geometric transformation to transform the image keypoints in the any of the image keypoints to the first coordinate system.

16. The computer program product according to claim 13, wherein the computer readable program code is configured to identify a given set of template descriptors matching the set of image descriptors by matching, based on the defined threshold, a subset of the given set of template descriptors to a subset of the set of image descriptors.

17. The computer program product according to claim 16, wherein the subset of the set of image descriptors comprises a first subset of image descriptors, wherein the given set of template descriptors comprises a first given set of template descriptors, wherein the given previously captured image comprises a first given previously captured image, and further comprising: computer readable program code configured to match, based on the defined threshold, a subset of a second given set of template descriptors to a second subset of the set of image descriptors, the second given set of template descriptors corresponding to a second given previously captured two-dimensional image of the three-dimensional object recorded at a third angle of rotation of the object, computer readable program code configured to add, to the first given set of template descriptors, any of the template descriptors in the second given set of template descriptors not in the first given set of template descriptors and any of the image descriptors not in the first given set of template descriptors, and computer readable program code configured to delete the second given set of template descriptors.

18. The computer program product according to claim 13, wherein the defined threshold comprises a confidence level.
